(19) United States
(12) Patent Application Publication
(10) Pub. No.: US 2005/0052363 A1
(43) Pub. Date: Mar. 10, 2005

(54) Method for displaying gray scales on plasma display panel and plasma display panel driver using the method

(76) Inventor: Jae-Seok Jeong, Suwon-si (KR)

Correspondence Address: MCGUIREWOODS, LLP, 1750 TYSONS BLVD, SUITE 1800, MCLEAN, VA, 22102, US

(21) Appl. No.: 10/910,362

(22) Filed: Aug. 4, 2004

(30) Foreign Application Priority Data
Aug. 5, 2003 (KR) 2003-0054046

(51) Int. Cl. G09G 3/28

(52) U.S. Cl. 345/63

(57) ABSTRACT

In a method for representing gray scales on a plasma display panel (PDP), and a PDP driver using the method, a load ratio of input video signals is generated. When the load ratio is low, a plurality of subfields is generated where the weight of the least significant bit (LSB) subfield from among the subfields may be minimized, (wherein the LSB subfield is a subfield with the minimum weight from among the subfields), and the minimum number of sustain pulses may be allocated to the LSB subfield.

This application claims the benefit of Korean Patent Application No. 2003-54046, filed on Aug. 5, 2003, which is hereby incorporated by reference for all purposes as if fully set forth herein.

### BACKGROUND OF THE INVENTION

1. Field of the Invention

The present invention relates to a method for displaying gray scales on a plasma display panel (PDP). More specifically, the present invention relates to a method for improving low gray scale representation on a PDP, and a PDP driver using the method.

2. Discussion of the Related Art

A PDP displays images derived from electrical signals by a plurality of discharge cells in a matrix format and selectively allowing them to emit light.

The PDP must support a gray scale display function in order to operate as a color display. The gray scale display is realized by dividing a single field into a plurality of subfields and performing time division control on those subfields.

An automatic power control (APC) method for controlling power consumption according to an average signal level, or a load ratio of frames to be displayed, may be used since the PDP's driving features require high power consumption. The APC method changes the APC levels according to the video data input load ratios and keeps power consumption below a predetermined level by varying the number of sustain pulses for each APC level.

FIG. 1 shows a conventional PDP gray scale representation method according to APC levels. The APC level is divided into three stages for simplicity, but the APC level may actually be divided into many stages, such as 128 or 256 stages.

Referring to FIG. 1, the APC 0 stage represents a completely dark or small display area video input, which corresponds to a minimum load ratio. In this case, less power is consumed and a relatively large number of sustain pulses are used, thereby providing a long sustain interval. The APC 2 stage represents a large, bright display area, which corresponds to a maximum load ratio. In this case, since a lot of power is consumed, a small number of sustain pulses are used to reduce power consumption, thereby providing a short sustain interval. The APC 1 stage represents an input video load ratio that is between the load ratios of the APC 0 stage and the APC 2 stage. In this case, an intermediate amount of power is consumed and approximately half the number of sustain pulses are used, thereby providing a sustain interval between the two stages.

When the load ratio is reduced and the sustain interval is lengthened when using the APC method, a further subfield can be provided to represent the gray scales, which is referred to as a variable subfield method. This method may effectively reduce contour noise.

PDP's with increased efficiencies display brighter images while using less power. PDP brightness is largely determined by the number of sustain pulses used for sustain per frame. Generally, 2,100 to 2,800 sustain pulses are used for per-frame sustain to obtain peak brightness of 650 to 1,000 cd/m². On the other hand, a PDP, which has efficiency features greater than 1.51 m/W, uses 1,400 to 1,800 sustain pulses for per-frame sustain to obtain the peak brightness of 1,000 cd/m². Consequently, the PDP consumes less power to achieve high brightness since it uses fewer sustain pulses than the conventional PDP. The PDP also has per-pulse light emitting brightness higher than that of the conventional PDP. That is, the conventional PDP has light emitting brightness of 0.3 to 0.4 cd/m², and the PDP has light emitting brightness of 0.5 to 0.8 cd/m₂.

FIG. 2 shows a variable subfield method for representing gray scales for the minimum APC level in the conventional PDP, and FIG. 3 shows a variable subfield method for representing gray scales for the maximum APC level.

Referring to FIG. 2, eleven subfields are used for the minimum APC level to obtain the peak brightness of 600 to 1,000 cd/m² in the conventional PDP. In this instance, there are 2,204 total sustain pulses (summation of X and Y electrodes), and the the least significant bit (LSB) subfield SF1 has eight sustain pulses.

Referring to FIG. 3, at the maximum APC level, the full-white brightness is approximately 150 cd/m², and twelve subfields are used. In this instance, there are 380 total sustain pulses (summation of X and Y electrodes), and the LSB subfield has one sustain pulse.

FIG. 4 shows a conceptual diagram for numbers of subfields and arrangement usage according to APC levels in the conventional PDP. Arrangement 1 of FIG. 2, having eleven subfields, is used when the APC level is less than a threshold level, and arrangement 2 of FIG. 3, having twelve subfields, is used when the APC level exceeds the threshold level.

PDP video input signals must be gamma corrected since the PDP has different gamma characteristics than the cathode ray tube (CRT). However, gamma correction using the PDP subfields fails to represent smooth low gray scales. Therefore, an error diffusion process is performed after the gamma correction to correct lost low-gray scale data. However, this error diffusion process may generate many problems. In particular, identification performance on the error-diffused pixels changes according to unit light emitting brightness of the LSB subfield.

With a PDP, the unit light emitting brightness per sustain pulse is increased. Accordingly, when error diffusion is performed for low-gray scale representation, the unit light emitting brightness of the LSB subfield is increased, which makes error-diffused pixels easy to see and worsens low-gray scale representation.

In particular, when displaying high APC level images, the number of sustain pulses and the unit light emitting brightness of the LSB subfield decrease, thereby permitting smooth representation of the low gray scales as shown in FIG. 5. On the other hand, when displaying low APC level images, the number of sustain pulses and the light emitting brightness of the LSB subfield increase, thereby highlighting the error-diffused pixels, which results in an irregular low-gray scale representation as shown in FIG. 6.

For example, regarding FIG. 3, when the brightness of one sustain pulse is approximately 0.45 cd/m², the light emitting brightness of the LSB subfield is approximately 0.45 cd/m², since the LSB subfield has a single sustain pulse at a high APC level. Since low gray scales may be smoothly represented when the light emitting brightness of the LSB subfield is less than 2.0 cd/m², the low gray scale is smoothly represented for a high APC level image as shown in FIG. 3. On the other hand, regarding FIG. 2, when the brightness of one sustain pulse is approximately 0.45 cd/m², the light emitting brightness of the LSB subfield is approximately 3.6 cd/m², since there are eight sustain pulses of the LSB subfield for a low APC level. Therefore, the low gray scales are not smoothly represented for a low APC level image.

### SUMMARY OF THE INVENTION

Accordingly, the present invention is directed to a method for representing gray scales on a PDP and a PDP driver using the method that substantially obviates one or more of the problems due to limitations and disadvantages of the related art.

This invention provides a method for representing gray scales on a PDP for improving low scale representation by minimizing a number of sustain pulses of an LSB subfield or a number of sustain pulses of the LSB subfield and its adjacent subfields and reducing corresponding unit light emitting brightness in the case of displaying an image with a low APC level on a PDP, and a PDP driver using the method.

Additional features of the invention will be set forth in the description which follows, and in part will be apparent from the description, or may be learned by practice of the invention.

The present invention discloses a method for representing gray scales on a PDP comprising generating a load ratio of video data, and generating subfields so that a weight of a least significant bit (LSB) subfield for a low load ratio is less than a weight of a LSB subfield for a high load ratio.

The present invention also discloses a driver for a plasma display panel (PDP) comprising a video signal processor that outputs video data, and a gamma corrector for correcting the video data and outputting the gamma corrected video data. An automatic power control (APC) unit detects a load ratio of the gamma corrected data, calculates an APC level according to the detected load ratio, generates a number of sustain pulses corresponding to the calculated APC level, and outputs that number. A sustain and scan pulse driver generates a subfield arrangement including a plurality of subfields according to an APC level output and a number of sustain pulses, generates a control signal based on the generated subfield arrangement to apply the control signal to a PDP, and establishes a weight of a least significant bit (LSB) subfield from among the subfield arrangement generated when the load ratio is low to be less than a weight of an LSB subfield from among the subfields generated when the load ratio is high. Each LSB subfield has the least weight of the subfield arrangement. An error diffuser for diffusing display errors on adjacent pixels, and a memory controller that receives data from the error diffuser, generates subfield data that corresponds to the subfield arrangement generated by the sustain and scan pulse driver, and applies the subfield data to the PDP.

The present invention also discloses a method for representing gray scales on a plasma display panel (PDP) comprising generating subfields so that a light emitting brightness of a least significant bit (LSB) subfield is less than a specific threshold value when a load ratio of an input video signal is low, wherein the LSB subfield has a minimum weight among the subfields.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a conventional PDP gray scale representation method according to APC levels.

FIG. 2 shows a variable subfield method for representing gray scales at a minimum APC level in a conventional PDP.

FIG. 3 shows a variable subfield method for representing gray scales at a maximum APC level in a conventional PDP.

FIG. 4 shows a conceptual diagram for numbers of subfields and arrangement usage according to APC levels in a conventional PDP.

FIG. 5 shows gray scale representations when the light emitting brightness of an LSB subfield is low in a conventional PDP.

FIG. 6 shows gray scale representations when the light emitting brightness of an LSB subfield is high in a conventional PDP.

FIG. 7 shows a configuration diagram of an image with a low APC level configured according to a gray scale representation method in a PDP according to an exemplary embodiment of the present invention.

FIG. 8 shows a configuration diagram of an image with a high APC level configured according to a gray scale representation method in a PDP according to an exemplary embodiment of the present invention.

FIG. 9 shows a conceptual diagram for showing numbers of subfields and arrangement usage according to APC levels in a subfield configuration following a gray scale representation method on a PDP according to an exemplary embodiment of the present invention.

FIG. 10 shows a PDP driver according to an exemplary embodiment of the present invention.

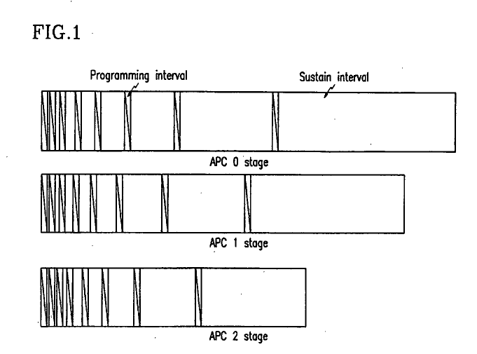

### DETAILED DESCRIPTION OF THE PREFERRED EMBODIMENTS

Reference will now be made in detail to an embodiment of the present invention, example of which is illustrated in the accompanying drawings.

A gray scale representation method for a PDP according to an exemplary embodiment of the present invention will now be described.

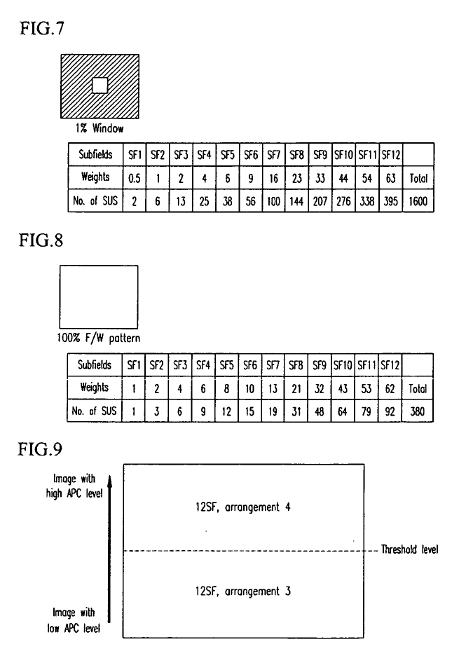

FIG. 7 shows a configuration diagram of an image with a low APC level configured according to a gray scale representation method in a PDP according to an exemplary embodiment of the present invention.

As shown, twelve subfields SF1 to SF12 of images with a low APC level are used to obtain the peak brightness of approximately 1,000 cd/m² for a PDP. The subfields are configured according to a gray scale representation method on the PDP according to an exemplary embodiment of the present invention, and there are approximately 1,600 total sustain pulses (summation of X and Y electrodes.)

Since the LSB subfield SF1 has two allocated sustain pulses, and the brightness per sustain pulse of the PDP is approximately 0.65 cd/m², the light emitting brightness of the LSB subfield SF1 is approximately 0.65 cd/m²×2=1.3 cd/m². As noted above, low gray scale representation is generally worsened in a PDP when the light emitting brightness of the LSB subfield is greater than 2.0 cd/m². In this case, since the light emitting brightness of the LSB subfield is less than 2.0 cd/m², low-gray scale representation may be enhanced.

Since sustain pulses are allocated to subfields proportionally to their weight, its weight may be minimized in order to minimize its allocated pulses. Subfield weight is typically a whole number, but in this exemplary embodiment of the present invention, the weight is set to be 0.5 in order to minimize the number of allocated sustain pulses and not worsen gray scale representation.

Since the conventional unit light emitting brightness of the PDP is approximately in the range of 0.5 to 0.8 cd/m², it is desirable to have less than four allocated sustain pulses for the LSB subfield so that the gray scale representation in a low APC level image may not be worsened.

FIG. 8 shows a configuration diagram of an image with a high APC level configured according to a gray scale representation method in a PDP according to an exemplary embodiment of the present invention.

As shown, the full-white light emitting brightness of the subfield for an image with a high APC level is approximately 210 cd/m², and there are 380 total sustain pulses (summation of X and Y electrodes.) In this case, since the LSB subfield SF1 has one allocated sustain pulse, and the brightness per sustain pulse of the PDP is approximately 0.65 cd/m², the light emitting brightness of the LSB subfield SF1 is approximately 0.65 cd/m²×1=0.65 cd/m². Smooth gray scale is therefore represented because the light emitting brightness of the LSB subfield SF1 is less than 2.0 cd/m². As described, with high APC level images, fewer sustain pulses are allocated to the LSB subfield, which may eliminate the potential problems with low gray scale representation.

FIG. 9 shows a conceptual diagram for showing numbers of subfields and arrangement usage according to APC levels in a subfield configuration following a gray scale representation method on a PDP according to an exemplary embodiment of the present invention.

Referring to FIG. 9, the subfield arrangement (the third arrangement) shown in FIG. 7 is used when the APC level is less than the threshold level, and the subfield arrangement (the fourth arrangement) shown in FIG. 8 is used when the APC level exceeds the threshold level.

According to an exemplary embodiment of the present invention, the third and fourth arrangements utilize a constant number of subfields, (e.g., twelve), irrespective of APC levels, unlike the conventional method where the number of subfields is reduced for low APC level images, which may worsen gray scale representation. Hence, the LSB subfield weight is scattered by using a constant number of subfields irrespective of the APC levels. Therefore, when the APC level decreases and the total number of sustain pulses increase, the number of sustain pulses allocated to the LSB subfield is less due to the constant number of subfields. In this exemplary embodiment, twelve subfields are used in the third and fourth arrangement, but more than twelve subfields may be used.

Consequently, when the APC level is less than the threshold level, the LSB subfield weight is minimized, thereby minimizing the number of sustain pulses allocated to the LSB subfield, as shown in the third subfield arrangement of FIG. 7. Thus, worsening of gray scale representation may be prevented on a PDP.

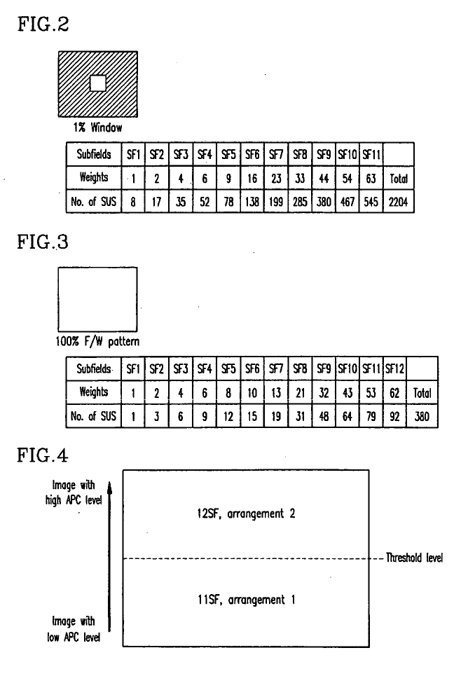

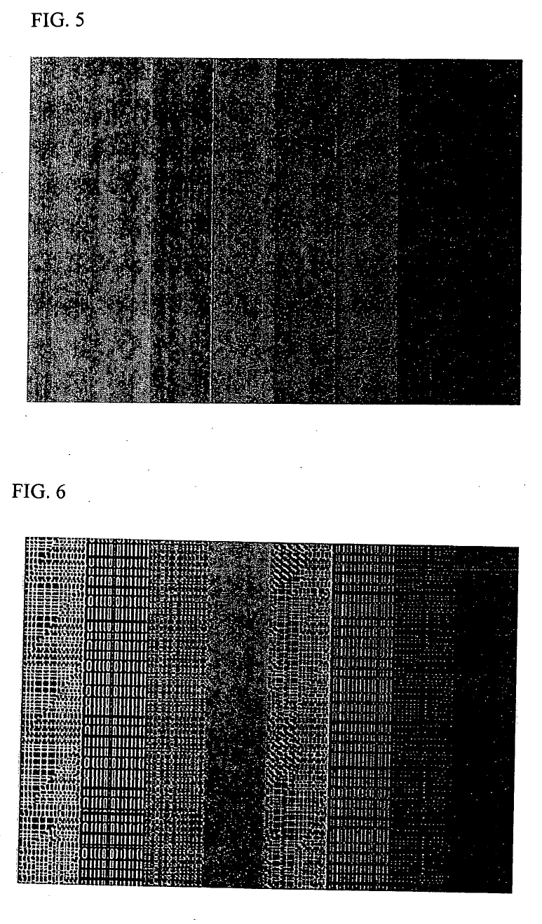

The threshold level represents an APC level by which the light emitting brightness of the LSB subfield may worsen low gray scale representation in the conventional PDP. Referring to FIGS. 2 and 3, when the APC level is lowered in the conventional PDP, the number of subfields decreases from twelve to eleven and the LSB subfield is allocated eight sustain pulses versus one. The threshold level may be established as the APC level with eight sustain pulses allocated to the LSB subfield.

The threshold level can be varied according to characteristics of the PDP, and obtained by experiments or repeated measurement.

Referring to FIGS. 7 and 8, where a constant number of subfields is used irrespective of the APC levels, certain subfield weights of a low APC level image differ from the corresponding subfield weights of a high APC level image.

In particular, in order to improve gray scale representation of the PDP according to an exemplary embodiment of the present invention, the weight of (the LSB subfield), (the LSB subfield and the LSB+1 subfield), (the LSB subfield, the LSB+1 subfield, and the LSB+2 subfield), (the LSB subfield, the LSB+1 subfield, the LSB+2 subfield, and the LSB+3 subfield), (the LSB subfield, the LSB+1 subfield, the LSB+2 subfield, the LSB+3 subfield, and the LSB+4 subfield), or (the LSB subfield, the LSB+l subfield, the LSB+2 subfield, the LSB+3 subfield, the LSB+4 subfield, and the LSB+5 subfield) of the image with low APC levels may be less than the weight of (the LSB subfield), (the LSB subfield and the LSB+1 subfield), (the LSB subfield, the LSB+1 subfield, and the LSB+2 subfield), (the LSB subfield, the LSB+l subfield, the LSB+2 subfield, and the LSB+3 subfield), (the LSB subfield, the LSB+1 subfield, the LSB+2 subfield, the LSB+3 subfield, and the LSB+4 subfield), or (the LSB subfield, the LSB+l subfield, the LSB+2 subfield, the LSB+3 subfield, the LSB+4 subfield, and the LSB+5 subfield) of the image with high APC levels.

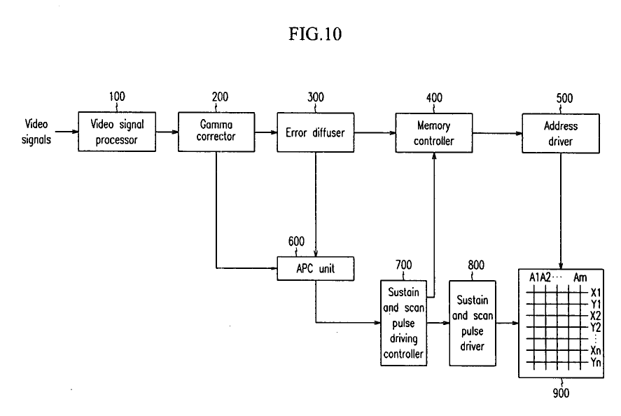

FIG. 10 shows a PDP driver according to an exemplary embodiment of the present invention.

The PDP driver comprises a video signal processor 100, a gamma corrector 200, an error diffuser 300, a memory controller 400, an address driver 500, an APC unit 600, a sustain and scan pulse driving controller 700, and a sustain and scan pulse driver 800.

The video signal processor 100 converts received video signals into digital video data.

The gamma corrector 200 receives the digital video data from the video signal processor 100, corrects gamma of the digital video data according to features of the PDP 900, and outputs gamma-corrected data to the APC unit 600.

The error diffuser 300 diffuses display errors on adjacent pixels so as to respectively correct the gray scales that are lost when converting the data output by the gamma corrector 200 into gray scales that can be represented by the PDP 900.

The memory controller 400 generates subfield data, based on the error diffuser 300 data output, that corresponds to the subfield arrangement configuration output by the sustain and scan pulse driving controller 700.

The address driver 500 generates address data that corresponds to the subfield data generated by the memory controller 400, and applies the address data to address electrodes A1 to Am of the PDP 900.

The APC unit 600 detects a load ratio based on the gamma corrector 200 data output and calculates an APC level according to the detected load ratio. It then generates a maximum number of sustain pulses and address pulse widths of the subfields corresponding to the calculated APC level, and outputs them.

The sustain and scan pulse driving controller 700 generates a subfield arrangement configuration corresponding to the maximum number of sustain pulses and the address pulse widths of the subfields output by the APC unit 600, and outputs it to the memory controller 400 and the sustain and scan pulse driver 800.

In an exemplary embodiment of the present invention, the sustain and scan pulse driving controller 700 generates a subfield arrangement (such as shown in FIG. 7) where the number of sustain pulses allocated to the LSB subfield is minimized when the APC level calculated by the APC unit 600 is less than the threshold level. The sustain and scan pulse driving controller 700 generates a general subfield arrangement (such as shown in FIG. 8) when the APC level exceeds the threshold level since the number of sustain pulses allocated to the LSB subfield is naturally minimized. In this exemplary embodiment, subfield arrangement configurations are generated so that the weight of the LSB subfield or the weights of the LSB subfield and its adjacent subfields for low APC level images may be less than the corresponding weight of the LSB subfield or the weights of the LSB subfield and its adjacent subfields for high APC level images.

The sustain and scan pulse driver 800 generates sustain pulses and scan pulses based on the subfield arrangement configuration output by the sustain and scan pulse driving controller 700, and applies them to scan electrodes X1 to Xn and sustain electrodes Y1 to Yn of the PDP 900.

According to an exemplary embodiment of the present invention, low gray representation may be improved by reducing the light emitting brightness of the LSB subfield in the PDP.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for representing gray scales on a plasma display panel (PDP), comprising:
generating a load ratio of video data; and
generating subfields so that a weight of a least significant bit (LSB) subfield for a low load ratio is less than a weight of a LSB subfield for a high load ratio.

2. The method of claim 1, wherein a number of subfields generated when the generated load ratio is low equals a number of subfields generated when the generated load ratio is high.

3. The method of claim 1, wherein at least one weight of the subfields that are generated when the generated load ratio is low differs from the corresponding weight of the subfields that are generated when the generated load ratio is high.

4. The method of claim 3, wherein the weights of the LSB subfield and its adjacent subfields that are generated when the generated load ratio is low are less than the corresponding weights of the LSB subfield and its adjacent subfields that are generated when the generated load ratio is high.

5. The method of claim 1, wherein the generated subfield weight of a LSB subfield for a low load ratio is not a whole number.

6. The method of claim 5, wherein the generated subfield weight of a LSB subfield for a low load ratio is less than 1.0.

7. The method of claim 2, wherein the number of subfields generated when the generated load ratio is low equals twelve.

8. The method of claim 2, wherein the number of subfields generated when the generated load ratio is low is more than twelve.

9. The method of claim 1, wherein a number of sustain pulses allocated to the LSB subfield for a low load ratio is less than four.

10. A driver for a plasma display panel (PDP), comprising:
an automatic power control (APC) unit for detecting a load ratio of video data, calculating an APC level according to the detected load ratio, generating a number of sustain pulses corresponding to the calculated APC level, and outputting that number;
a sustain and scan pulse driver for generating a subfield arrangement including a plurality of subfields according to an APC level output and a number of sustain pulses, generating a control signal based on the generated subfield arrangement to apply the control signal to a PDP, and establishing a weight of a least significant bit (LSB) subfield from among the subfield arrangement generated when the load ratio is low to be less than a weight of an LSB subfield from among the subfields generated when the load ratio is high, each LSB subfield has the least weight of the subfield arrangement;
and
a memory controller for receiving the video data, generating subfield data that corresponds to the subfield arrangement generated by the sustain and scan pulse driver, and applying the subfield data to the PDP.

11. The driver of claim 10, wherein the sustain and scan pulse driver constantly maintains the number of subfields included in a generated subfield arrangement irrespective of the load ratio.

12. The driver of claim 10, wherein the sustain and scan pulse driver controls at least one of the respective weights established to the subfield arrangement that is generated when the load ratio is low to be different from the corresponding weights from among the weights established to the subfield arrangement that is generated when the load ratio is high.

13. The driver of claim 12, wherein the sustain and scan pulse driver controls the weights of the LSB subfield and its adjacent subfields in the subfield arrangement that is generated when the load ratio is low to be less than the corresponding weights of the LSB subfield and its adjacent subfields in the subfield arrangement that is generated when the load ratio is high.

14. The driver of claim 10, wherein the weight of the LSB subfield from among the subfield arrangement generated when the load ratio is low is not a whole number.

15. The driver of claim 14, wherein the weight of the LSB subfield from among the subfield arrangement generated when the load ratio is low is less than 1.0.

16. The driver of claim 11, wherein the sustain and scan pulse driver constantly maintains twelve subfields irrespective of the load ratio.

17. The driver of claim 11, wherein the sustain and scan pulse driver constantly maintains more than twelve subfields irrespective of the load ratio.

18. A method for representing gray scales on a plasma display panel (PDP), comprising:
generating subfields so that a light emitting brightness of a least significant bit (LSB) subfield is less than a specific threshold value when a load ratio of an input video signal is low, wherein the LSB subfield has a minimum weight among the subfields.

19. The method of claim 18, wherein the light emitting brightness of the LSB subfield is determined by a number of sustain pulses allocated to the LSB subfield, and unit light emitting brightness of a PDP, the number of sustain pulses changing according to the load ratio of the input video signal.

20. The method of claim 19, wherein the number of sustain pulses allocated to the LSB subfield is the minimum number of sustain pulses among the subfields.
